(19) United States
(12) Patent Application Publication
(10) Pub. No.: US 2010/0067974 A1
(43) Pub. Date: Mar. 18, 2010

(54) Binder for holding materials

(76) Inventor: Sarvjeet S. Bindra, San Diego, CA (US)

Correspondence Address: Frank J. Bonini, Jr.;Harding, Earley, Follmer & Frailey, 1288 Valley Forge Road, P.O. Box 750, Valley Forge, PA, 19482-0750, US

(21) Appl. No.: 12/283,769

(22) Filed: Sep. 16, 2008

(51) Int. Cl. B42F 13/00

(52) U.S. Cl. 402/75; 402/80 R

(57) ABSTRACT

A lightweight binder for securing papers, the binder being constructed from a polyfoam material and having a closure to secure the binder panels and paper together, a mesh pocket also being provided with a closure for storing items therein. The polyfoam layer may be laminated with other layers which form the a binder surfaces.

### BACKGROUND OF THE INVENTION

1. Field of the Invention

The present invention relates to binders and more particularly to lightweight ring binders for holding looseleaf sheets.

2. Brief Description of the Related Art

Binders are used widely as a secure housing for documents and for holding papers together. Ring binders are a popular type of binder which are constructed using rings that are sized to fit corresponding apertures in sheets of paper. Generally, a series of metal rings are employed with a locking mechanism which permits opening of the rings so that looseleaf sheets may be placed on the ring prongs and secured thereby. The rings are then closed together to secure the looseleaf sheets therein. Many sizes of binders exist. For example, some commonly produced ring binders have thicknesses of from about ½″ up to 4 inches. The ring mechanism often is secured to the spine of the binder.

Binders may be constructed from cardboard which often is used as a core and is covered with a plastic or vinyl material. Cloth also has been used as a covering over cardboard. In some cases the cardboard tends to bend a curl over periods of use. The cardboard may be affected by the presence of moisture, such as humidity in the air, or exposure to the elements, such as rain. Cardboard may warp and also is subject to being crimped or misshapen, particularly at the corners (e.g., through use or being dropped). Another type of binder construction involves the use of pressboard. Pressboard may be used as an alternative to cardboard. Though pressboard may be more rigid than cardboard, binders constructed from pressboard have been known to split or crack leaving the front or back cover with a portion thereof that is loose or limp. The binder therefore must be discarded when this happens.

Binder rings often are constructed from metal, such as, for example, steel or tin, and may be plated with nickel to provide a pleasing finish. However, the use of metal, though important for its durability, adds weight to the binder. The weight of the binder may be significant even before any papers or other articles are placed therein. Once articles, such as looseleaf papers or dividers, are placed in the binders, the weight increases, and with use, as more papers are inserted into the binder, the binder grows even heavier. Binders often are used by school age children. In some cases, binders are used to separate papers for a given subject or discipline, and many times a different binder is required for each subject. In other words, a student may use one binder for math (e.g., a math binder), another for science, and so on. While the binders generally are useful to separate papers, the binder components, such as cardboard or pressboard, the coverings, as well as the metal ring mechanisms, contribute to the weight. Coupling the binder weight with the added weight of additional papers for a given subject that are placed within the binder, and multiplying that weight by the number of subjects for which binders are used, there is an appreciable burden on the student.

Where a student's storage area, such as a homeroom desk or locker, is remote from the classrooms where the books and binders are needed for use, often the student is required to carry materials for multiple subjects (such as text books and binders) from one classroom to another. The student may do this throughout the day.

A need exists for a binder which is durable, yet economical as well as lightweight.

### SUMMARY OF THE INVENTION

An improved binder for securing looseleaf papers is provided. According to preferred embodiments, the binder is constructed to be of lightweight material which is durable and resistant to moisture.

Embodiments of the binder include a closure which is adapted to secure the end panels of the binder. The closure is adjustable to accommodate the thickness of the binder as well as the contents of paper secured in the binder.

The binder may be configured with a ring mechanism for engaging holes in looseleaf papers.

Preferred embodiments of the binder provide a plurality of holding features, including a pocket which may be constructed to add minimal weight to the binder. A pocket may be configured so that a binder panel may form one pocket boundary and a mesh panel attached to the binder panel to form another pocket boundary.

Preferred embodiments may include pockets provided on the interior of the binder.

The binder preferably may be constructed from lightweight polymer materials which are capable of being formed into a foldable configuration.

These and other advantages are provided by the invention.

### BRIEF DESCRIPTION OF THE DRAWING FIGURES

FIG. 1 is a front perspective view of a binder according to the present invention shown in a folded configuration, as viewed from the left side looking at the front.

FIG. 2 is a sectional view of a portion of the binder panel taken along the line 2-2 of FIG. 3.

FIG. 3 is an elevation view of the binder of FIG. 1 shown in an unfolded configuration.

FIG. 4 is a rear elevation view of the binder of FIG. 1 shown with a pocket.

FIG. 5 is a right side elevation view of the binder of FIG. 1 shown in a closed configuration with a closure holding the front and rear panels together.

FIG. 6 is an enlarged view of the closure shown in FIG. 5, illustrated in a closed configuration, with the latching member shown unlatched in phantom.

### DETAILED DESCRIPTION OF THE PREFERRED EMBODIMENTS

Referring to the drawing figures, there is illustrated a binder 10 in accordance with the invention. The binder 10 is illustrated having a front panel 11, a spine 12 and a rear panel 13. The front panel 11, spine 12 and rear panel 13 preferably are constructed from a lightweight, and preferably, water-resistant material. Examples of materials which may be used to construct the binder 10 include polyfoam materials, and more particularly, polyfoam materials such as, for example, polystyrene, extruded polystyrene, polyurethane, and polyethylene. The binder 10 may be formed from a sheet of material which is or includes a polyfoam. According to the embodiment illustrated in the drawing figures, the binder 10 includes a spine 12, front panel 11 and rear panel 13. The binder 10 may have a binder body 15 (see FIG. 6), which according to preferred embodiments includes a polyfoam layer 25. A covering layer of material preferably is provided on each side of the polyfoam layer 25. The polyfoam layer 25 and covering layers may, for example, be bonded together under heat and pressure. In a preferred embodiment, the spine 12, front panel 11 and rear panel 13 are formed from a sheet of material which is shaped and configured for folding, such as, for example at the folding axes 21, 22, 23 and 24. A sheet of material from which the binder 10 is formed may be an extruded material. The spine 12 front panel 11 and rear panel 13 may form the binder body 15, which may be cut from a sheet material.

As illustrated in FIG. 2, according to preferred embodiments, the front panel 11, spine 12 and rear panel 13 are formed as a multi-layer laminate comprising a polyfoam layer 25 with a first surface 26 and a second surface 27, a first surface layer 28 disposed on the first surface 26 of said polyfoam layer 25 and a second surface layer 30 disposed on the second surface 27 of the polyfoam layer 25. The first surface layer 28 and second surface layer 30 preferably provide surfaces which are water resistant and durable, as well as being lightweight. The first surface layer 28 and second surface layer 30 may be constructed from the same composition as each other, which preferably is a lightweight composition. The layers 25, 28, 30 are bonded together. Bonding of the layers 25, 28, 30 may be accomplished under conditions of heat, pressure or both. For example, according to alternate embodiments, the layers 25, 28 and 30 may be attached using an adhesive. The multi-layer laminate of layers 25, 28 and 30 may be used to form the binder 10. The first surface layer 28 may form the outer surfaces of the front panel 11, spine 12 and rear panel 13. The second surface layer may form the inner surfaces of the front panel 11, spine 12 and rear panel 13.

Referring to FIG. 3, there is illustrated a plurality of folding axes 21, 22, 23, 24. According to a preferred embodiment, the folding axes 21, 22, 23 and 24 may be configured from the folding impressions or grooves 31, 32, 33, 34 provided on the binder body 15. The binder body 15, which according to preferred embodiments may be formed from a multi-layered laminate, such as, for example, those layers 25, 28 and 30, and, according to one preferred embodiment, may be impressed to form the grooves 31, 32, 33, 34. Folding grooves 31, 32, 33, 34 according to another embodiment, may be cut into the binder body 15. For example, according to one embodiment, the grooves 31, 32, 33, 34 may be cut into the polyfoam layer 25 prior to the lamination of the layer 25 with the surface layers 26, 27. The grooves 31, 32, 33, 34, for example, may be cut into the panel 25, or alternately, impressed into the panel 25, or a combination of both. The folding axes 21, 22, 23, and 24 facilitate folding of the front panel 11 and rear panel 13. The folding axes 21, 22, 23, 24 preferably are provided to facilitate swinging the binder panels 11, 13 toward and away from each other, respectively, to open and close the binder 10. According to preferred embodiments, the folding axes 21, 22, 23, 24 may be provided in pairs to alleviate the pressure placed on the adjacent binder portions, such as between the first panel 11 and spine 12, and between the rear panel 13 and spine 12.

In accordance with preferred embodiments, the first surface layer 28 (which forms the surface of the front panel 11) may serve as a hinging mechanism for facilitating swinging of the front panel 11 relative to the spine 12 and/or rear panel 13. The hinging mechanism may include the removal, scoring, compression of one or more of the other layers of the multi-laminate structure, such as the polyfoam layer 25 and second surface layer 30 (the layer forming the interior surface of the binder 10. According to a preferred embodiment, the first surface layer 28 and second surface layer 30 form a hinge along one or more longitudinal folding axes 21, 22, 23, 24. According to a preferred embodiment, the polyfoam layer 25 is removed or compressed in the locations of the folding axes 21, 22, 23, 24 to provide improved flexibility for folding. A folding space or groove 31, 32, 33, 34 may form the folding axes 21, 22, 23, 24, respectively. Though a preferred configuration with a plurality of folding axes is shown, folding axes may be provided in different numbers depending on the aesthetics, as well as the binder thickness.

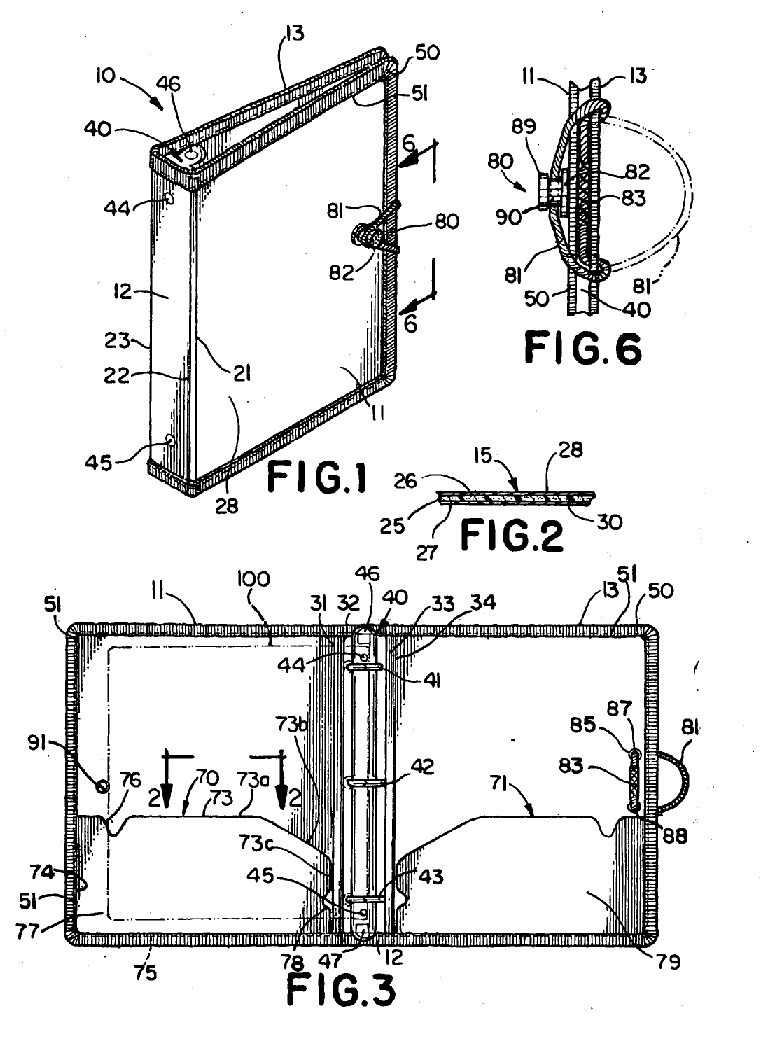

Referring to FIGS. 1 and 3, a paper securing mechanism, such as a ring mechanism 40 is provided for holding looseleaf pages (such as the page 100 shown in broken line representation). The ring mechanism 40 may be any of those suitable for securing looseleaf pages to the ring prongs 41, 42, 43. The exemplary ring mechanism 40 is illustrated having attachment means comprising rivets 44, 45 which secure the mechanism 40 to the binder spine 12. Locking flanges 46, 47 are provided at each end of the mechanism 40 for operating the mechanism 40 to open and close the rings 41, 42, 43. Though the ring mechanism 40 is shown mounted to the spine 12, the mechanism 40 may be mounted to the front panel 11 or rear panel 13.

The binder 10 preferably is provided with an edge portion defining a perimeter of the spine 12, front panel 11 and rear panel 13 with a treatment 50 applied thereon. According to the embodiment illustrated in the drawing figures, the treatment 50 may be formed from a tape or border which may be constructed from fabric. The treatment 50 may be folded to cover the edges of the front panel 11, spine 12 and rear panel 13. The treatment fabric 50 is shown attached with stitching 51, though adhesive or other suitable attachment means may be used.

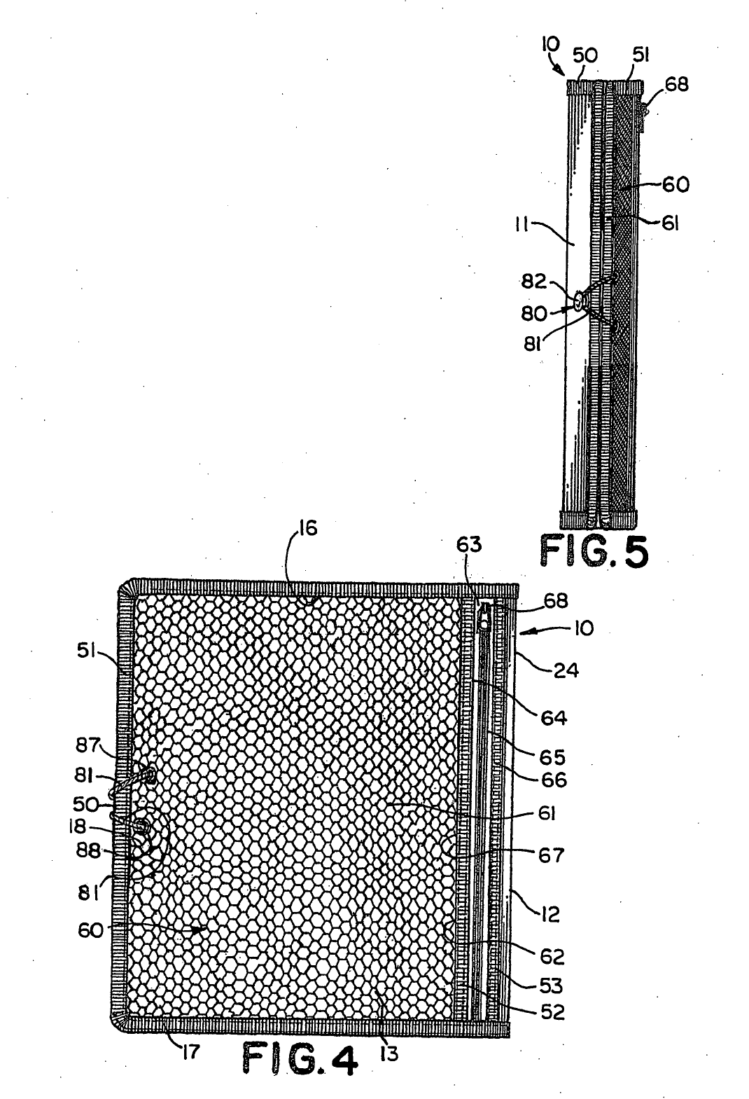

The binder 10 preferably includes one or more holding features for holding items, such as papers, or even pencils, erasers, notepads and other items. As shown in FIG. 4, the binder 10 is illustrated having a first holding feature configured as a pocket 60 which is closable and disposed on the rear panel 13. Preferred embodiments of the binder 10 provide a plurality of holding features, including a pocket 60 which may be constructed from a light weight material. The pocket 60 may be configured from a binder panel, such as the rear panel 13 which forms one pocket boundary, and a mesh panel 61 attached to the binder rear panel 13. The mesh panel 61 preferably permits viewing of contents within the pocket 60. The mesh panel 61 illustrated is attached to the rear panel 13 at its edges, including the top edge 16, bottom edge 17 and side edge 18. The mesh panel 61 is fixed at three of its edges to each of the rear panel edges 16, 17, 18, respectively. Preferably, the mesh panel 61 is secured to the rear panel 13 by the border or treatment fabric 50. The mesh panel 61 and treatment fabric 50 may be secured together by stitching 51, adhesive, or a combination of these or other fastening means. The mesh panel 61 is illustrated secured at least one end thereof to a zipper closure 63. The zipper closure 63 mounts the mesh panel 61 to the binder 10 and provides a means for regulating access to the pocket contents The zipper closure 63 has a zipper pull 68 and has a first portion 64 which is secured with an edge of the mesh panel 61 and a second portion 65 which is mounted to the binder body 15, shown in the exemplary embodiment mounted to the rear panel 13. Stitching 66 is used to attach the closure second portion 65 to the panel 13. Stitching 67 also is shown attaching the first portion 64 and mesh panel 61 together. The closure 63 preferably is mounted at the edge 62 of the rear panel 13 proximate to the binder spine 12. Though not shown, adhesive may be used to attach the closure 63 to the binder body 15. According to a preferred embodiment, a first tape portion 52 and a second tape portion 53 may be used to facilitate mounting of the zipper closure 63 to the binder 10. The first tape portion 52 and second tape portion 53, for example, may optionally be provided as part of the zipper closure 63, or used to mount the first portion 64 and second portion 65 to the pocket panel 61 and rear panel 13, respectively.

Preferred embodiments may optionally include one or more pockets provided on the interior of the front and rear panels 11, 13. In the embodiment illustrated in FIG. 3, first and second pockets 70, 71, respectively, are provided. The first pocket 70 has an open edge 73 and a secured perimeter including the edges 74, 75, 76. The first pocket 70 is provided on the interior of the first panel 11. The second pocket 71 is configured similar to the first pocket 70 and is provided on the interior of the second panel 13. The first pocket 70 may comprise a panel 77 which preferably may be constructed from plastic or other flexible material. The first pocket panel 77 is shown secured to the first panel interior by a weld 78 disposed along the perimeter of its innermost edge 76. The other secured edges 74, 75 of the first pocket panel 77 are shown secured with the stitching 51. Alternately, or in addition thereto, the panel edges 74, 75 may be secured to the front panel interior with a weld (not shown). The second pocket panel 79 may be attached in the manner described herein in connection with the first pocket panel 77.

According to preferred embodiments, the binder 10 has a closure 80 which is adapted to secure the ends panels of the binder. The closure 80 is adjustably configured to accommodate the thickness of the binder panels 11, 13 as well as the contents of paper 100 secured in the binder 10. A preferred embodiment of the closure 80 is shown in FIGS. 1, 3, 4, 5 and 6 including an elastic member 81 and a holding element or retainer 82. The elastic member 81 is shown held on the rear panel 13. The elastic member 81 may be formed from a length of elastic whose ends are secured together by a crimping element 83. Apertures 85, 86 are provided in the rear panel and include grommets 87, 88 through which the elastic member 81 passes. The grommets 87, 88 are illustrated in a preferred configuration and facilitate passage and durability of the elastic member 81 therethrough. The retainer 82 is provided on the first panel 11 and receives the elastic member 81. The retainer 82 preferably has an enlarged holding portion 89 and a seating portion 90. The closure 80 facilitates securing the first panel 11 and said second panel 13 together. According to a preferred embodiment, the retainer 82 may be installed using a fastening element, such as the screw 91, which may be installed in a matingly threaded bore (not shown) provided in the retainer 82. Other suitable means for installing the retaining member 82 on the binder panel 11 may be used, such as, for example rivets, adhesive, or the like.

While the invention has been described with reference to specific embodiments, the description is illustrative and is not to be construed as limiting the scope of the invention. Various modifications and changes may occur to those skilled in the art without departing from the spirit and scope of the invention described herein and as defined by the appended claims.

What is claimed is:

1. A binder for securing papers comprising:
a) a front panel,
b) a spine; and
c) a rear panel;
wherein said front panel, spine and rear panel comprise a lightweight material.

2. The binder of claim 1, wherein said front panel, spine and rear panel comprise a polyfoam material.

3. The binder of claim 2, wherein said polyfoam material selected from the group consisting of polystyrene, extruded polystyrene, polyurethane, and polyethylene.

4. The binder of claim 1, including a ring mechanism for holding looseleaf pages therein.

5. The binder of claim 4, wherein said ring mechanism is attached to one of the spine, front panel or rear panel.

6. The binder of claim 1, wherein said front panel, spine and rear panel are formed as a multi-layer laminate comprising a polyfoam layer a first surface layer disposed on one side of said polyfoam layer and a second surface layer disposed on another side of said polyfoam layer.

7. The binder of claim 7, wherein said layers are bonded together under conditions of heat, pressure or both.

8. The binder of claim 7, wherein said binder has an edge portion, and wherein a treatment is applied to said edge portion.

9. The binder of claim 8, wherein said treatment comprises a border.

10. The binder of claim 9, wherein said border includes a tape.

11. The binder of claim 10, wherein said tape is constructed from a fabric.

12. The binder of claim 10, further including at least one pocket.

13. The binder of claim 12, including a closable pocket disposed on said rear panel.

14. The binder of claim 13, wherein said pocket is constructed from a lightweight material.

15. The binder of claim 14, wherein said lightweight material comprises a mesh material

16. The binder of claim 15, wherein said mesh material provides viewing of the pocket contents.

17. The binder of claim 13, including a zipper.

18. The binder of claim 12, wherein said front panel has an inner surface and an outer surface, and wherein said rear panel has an inner surface and an outer surface, the binder including at least one pocket provided on an inner surface of one or the other or both of said front panel inner surface and said rear panel inner surface.

19. The binder of claim 12, further including at least one closure for securing said first panel and said second panel together.

20. The binder of claim 19, wherein said closure includes at least one elastic element and a holding element.

21. The binder of claim 20, wherein said elastic element is disposed on at least one of said front panel and said second panel, and said holding element is disposed on the other one of said front panel and said second panel.

22. A binder for securing papers comprising:
a) a front panel,
b) a spine; and
c) a rear panel;
d) wherein said front panel, spine and rear panel are formed as a multi-layer laminate comprising a polyfoam layer, a first surface layer disposed on one side of said polyfoam layer, and a second surface layer disposed on another side of said polyfoam layer, said polyfoam layer being selected from the group consisting of polystyrene, extruded polystyrene, polyurethane, and polyethylene;
e) a ring mechanism for holding looseleaf pages therein, said ring mechanism being attached to one of the spine, front panel or rear panel;
f) said front panel, rear panel and spine each having edge portions,
g) a fabric tape applied to the edge portions of said front panel, said rear panel and said spine;
h) at least one closable pocket constructed from a mesh material and being disposed on said rear panel to form with said rear panel one side of a pocket the other side being formed by said rear panel, said mesh portion and said rear panel being closed at least one zone and having at least one opening with a zipper disposed thereon to regulate entry into said mesh pocket defined thereby; and
i) wherein said front panel has an inner surface and an outer surface, and wherein said rear panel has an inner surface and an outer surface, and wherein there is at least one pocket provided on an inner surface of one or the other or both of said front panel inner surface and said rear panel inner surface;
j) at least one closure for securing said first panel and said second panel together, said closure including at least one stretchable element and at least one holding element, said stretchable element is disposed on at least one of said front panel and said second panel, and said holding element is disposed on the other one of said front panel and said second panel.
